(19) United States
(12) Patent Application Publication
(10) Pub. No.: US 2009/0122744 A1
(43) Pub. Date: May 14, 2009

(54) Selective relaying for wireless networks

(76) Inventors: Alexander Maltsev, Nizhny Novgorod (RU); Sergey Tiraspolsky, Nizhny Novgorod (RU); Andrey Pudeyev, Nizhny Novgorod (RU); Alexander Maltsev, JR., Nizhny Novgorod (RU)

Correspondence Address: TROP, PRUNER & HU, P.C., 1616 S. VOSS RD., SUITE 750, HOUSTON, TX, 77057-2631, US

(21) Appl. No.: 12/215,903

(22) Filed: Jun. 30, 2008

Related U.S. Application Data
(60) Provisional application No. 60/986,775, filed on Nov. 9, 2007.

(51) Int. Cl. H04W 4/00

(52) U.S. Cl. 370/315

(57) ABSTRACT

A relay may partially decode a frame to get enough information to know when to amplify and transmit the frame to a user. By limiting transmission in this way, less interference may be generated in some cases. By using only limited decoding, the relay overhead may be reduced in some embodiments.

### CROSS-REFERENCE TO RELATED APPLICATIONS

This application claims the benefit of Provisional Application No. 60/986,775, filed Nov. 9, 2007.

### BACKGROUND

This relates generally to relays or repeaters that forward information from a transmitter to a remote receiver.

Relays or repeaters allow a transmitter to send a wireless signal to a receiver that is beyond the range normally accessible by the transmitter. It allows wireless networks to be extended with less cost.

Metropolitan area networks may provide broadband access to subscribers in remote locations. For example, IEEE 802.16e, also known as Mobile WiMAX, integrates relays from multi-hop communications. See Broadband Wireless Access, WirelessMan, 802-16e-2005, IEEE Standards Association, Piscataway, N.J. 08855, U.S.A. A relay enhanced IEEE 802.16j,m network can provide large area radio coverage, achieve a high quality of service, and can be economically deployed and operated. See Multihop Relay and Advanced Air Interface, available from IEEE Standards Association.

Similarly, in IEEE 802.15.3c (Millimeter Wave, WPAN/WLAN) relay stations provide radio coverage for large buildings, corridors, and reliably throughput communication between rooms, floors, and spaced areas in residential and office environments. See IEEE 802.15c-2003 WPAN Task Group, draft text DF3.

### BRIEF DESCRIPTION OF THE DRAWINGS

FIG. 1 is a depiction of a relay in accordance with one embodiment of the present invention;

FIG. 2 is a network topology for one embodiment of the present invention;

FIG. 3 shows a downlink and uplink subframe in accordance with one embodiment of the present invention;

FIG. 4 is a schematic depiction of a relay in accordance with another embodiment of the present invention;

FIG. 5 is a system depiction for one embodiment of the relay shown in FIG. 4; and

FIG. 6 is a depiction of a downlink subframe for the embodiment shown in FIG. 4.

### DETAILED DESCRIPTION

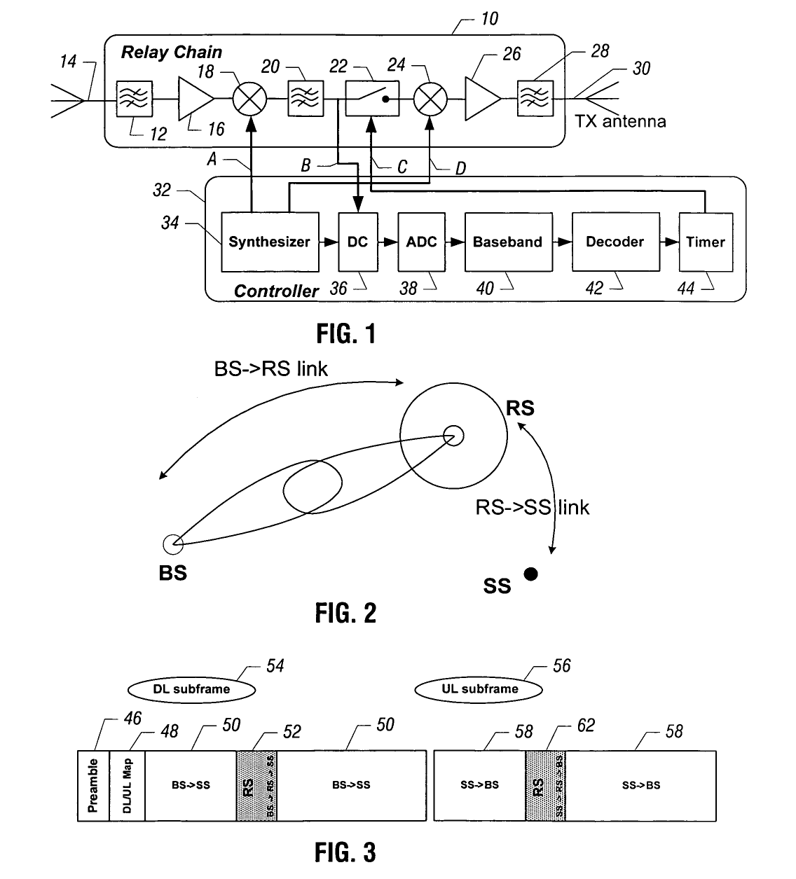

Referring to FIG. 1, a relay may include a receive antenna 14 coupled to a relay chain 10. The relay chain 10 is coupled to a controller 32. Thus, the antenna 14 may receive a signal from a base station in a wireless network. It may forward a signal through a transmit antenna 30 to a subscriber station in that network. Operation of relay chain 10 may be controlled by the controller 32.

The relay chain 10 includes a band-pass filter 12, an amplifier 16, a mixer 18, a low-pass filter 20, a switch 22, a mixer 24, an amplifier 26, and a band-pass filter 28, coupled to the antenna 30.

The controller 32 may include a synthesizer 34 that provides a signal for the mixer 18. A down converter (DC) 36 may receive a signal from the relay chain to be selectively decoded. The DC 36 is coupled to an analog-to-digital converter 38 which couples to a baseband unit 40. The baseband unit 40 is coupled to a decoder 42. The decoder 42 output is provided to a timer 44. The timer 44 provides an output control signal to control the on or off state of the switch 22. In addition, a signal indicated at B may be provided from the low-pass filter 20 to the DC 36. The synthesizer 34 also issues a signal D to the mixer 24.

In some embodiments, the controller 32 enables selective decoding of a signal received by the relay chain 14. For example, in an IEEE 802.16j,m system, the relay chain 10 and controller 32 may decode a map field from a downlink subframe. The map field describes allocation of data within downlink and uplink subframes. The map field may always be located in a readily locatable subframe address in some systems. Thus, rather than decode the entire uplink and downlink subframe, only the map field may be decoded in the signal received via the link B in FIG. 1. This reduces the overhead on the relay chain 10. In addition, it is not necessary for the relay chain 10 to re-encode any data.

The map field information may be used to determine which subscriber stations, in what time frames, will be receiving information. This may be used by the timer 44 to then turn the switch 22 on and off so that the relay chain 10 only operates during those time frames when pertinent subscriber stations, serviced by the relay chain 10, are to receive signals.

Since it is not necessary to re-encode any information, the system, shown in FIG. 1, operates as an amplify and forward relay and does not need to decode the entire set of information that is received and then re-encode it for subsequent transmission. An amplify and forward relay merely amplifies and retransmits the received signal.

On the other hand, the amount of interference and the likelihood of collisions may be reduced, in some embodiments, because of the reduced information that gets relayed by the relay chain 10, compared to a system that does not do selective decoding and selective relaying. That is, retransmission only occurs for pertinent subscriber stations in pertinent time frames in some embodiments.

As another example, service information contained in the beacon fields of an 802.15.3 superframe may be used in the same way to enable selective decoding and selective relaying of only information pertinent to subscriber stations served by the relay.

Thus, referring to FIG. 2, the base station to relay station link extends from the base station BS to the relay station RS. The relay station then selectively forwards information on the RS to SS link to the subscriber station SS, as indicated in FIG. 2.

The downlink subframe 54 may then include a preamble 46, the downlink and uplink map 48, data 50 for the base station to each subscriber station, and the relay station identifying information 52. The base station to subscriber station data 50 may effectively be transmitted in an amplify and forward fashion only to the correct subscriber station in the correct time frames so that it is simply forwarded without decoding, other than the limited decoding described above, directly to the pertinent subscriber station.

The uplink subframe 56 includes the subscriber station to base station data 58 for each subscriber station and the relay station identifying information 62.

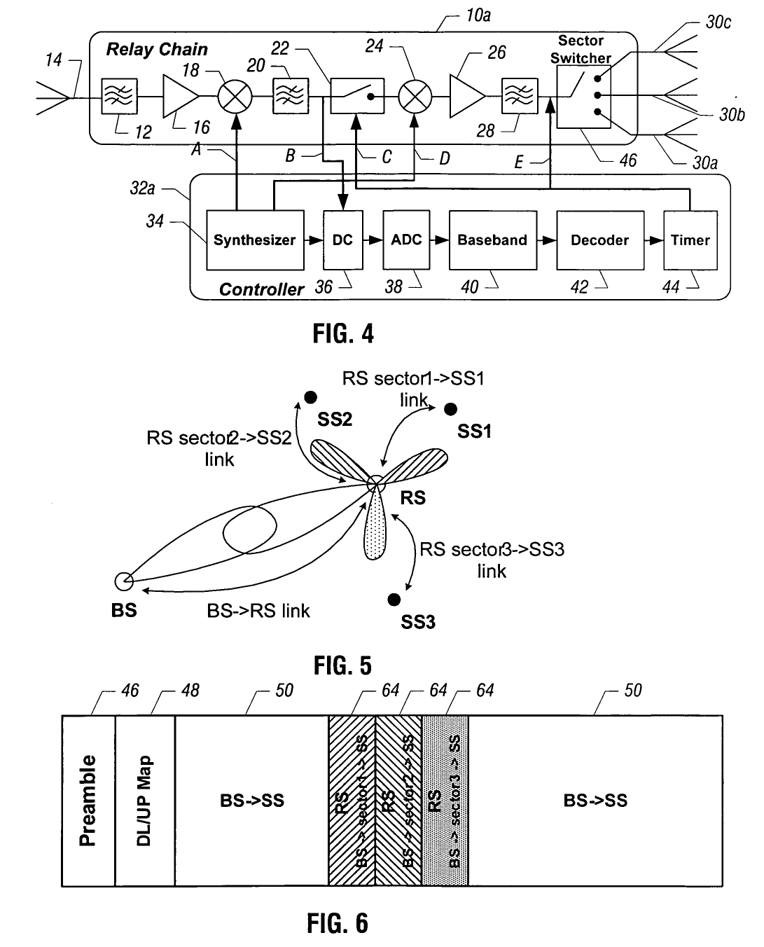

Referring to FIG. 4, in accordance with another embodiment, a sectorized antenna chain 30a, 30b, and 30c may be connected to a sectorized switcher 46. Thus, as shown in FIG. 5, a sectorized antenna may transmit a signal that is directed to a particular subscriber station SS1, SS2, SS3, each subscriber station located in a different pie-shaped sector relative to the antenna chain 30. By appropriate positioning of the relay station RS, relative to the subscriber stations, a sectorized antenna can transmit, in only a particular sector direction, for the appropriate subscriber station at the appropriate times and with the appropriate signals. In contrast to the embodiment shown in FIG. 2, which may use omni-directional broadcasting, sectorized or directional broadcast transmission may be utilized to reduce interference and collisions.

Returning to FIG. 4, the signal from the timer 44 is used not only to control the switch 22, but it also provides a signal to the sector switcher 46 to indicate which antenna should be used, depending on the location of the subscriber station that is to receive the signal at a particular time. Thus, the correct sectorized antenna 30a, 30b, or 30c is selected by the sector switcher 46 to transmit to the subscriber station that is supposed to receive the signal during the pertinent time period identified by the timer 44. Information may be provided in the map field information 48 that gives the subscriber station location. Of course, more or less antennas 30 may be used.

By using high antenna gain and narrow beamwidths, the quality of service may be improved. For relay station to subscriber station links, the sectorized directional transmit antennas 30a-30c may be used for the downlink. For uplink retransmission, the same antenna system may be used with another relay chain that amplifies and retransmits signals in opposite directions.

A downlink frame, shown in FIG. 6, includes individual relay station fields 64 for each of the three sectors illustrated in FIG. 5. Of course, more sectors or less sectors may be utilized in some embodiments. In addition, other types of directional antennas may be utilized.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
decoding a part of a received signal, to obtain information about allocations of data that are to be retransmitted by a relay, the information including a list of users communicating through the relay and not decoding another part of the received signal;
amplifying only a portion of the received signal that correspond to a user communicating through the relay; and
transmitting the portion of the received signal that was amplified.

2. The method of claim 1 wherein said information is a map field.

3. The method of claim 1 wherein a portion of the received signal that is amplified and transmitted is not re-encoded.

4. The method of claim 1 wherein said information is service information contained in a beacon field of a superframe.

5. The method of claim 1 wherein transmitting is sectorized transmitting of the portion in a sector occupied by a subscriber station used by a user.

6. The method of claim 1 wherein said transmitting includes using a directional antenna.

7. The method of claim 1 including transmitting using a relay chain and a controller, said controller to use said information to control a switch in said relay chain to cause transmission to occur in a time slot when said user is communicating through said relay.

8. The method of claim 7 including transmitting only during the time slots in which users of said relay are communicating.

9. An apparatus comprising:
a decoder to decode information describing allocations of data in a frame, including a time slot when a subscriber station is to communication, without decoding the rest of the frame;
a device to control the transmission of the frame based on the time slot; and
an amplifier to selectively amplify information in the time slot.

10. The apparatus of claim 9 including a sectorized antenna.

11. The apparatus of claim 10 wherein said sectorized antenna is a directional antenna.

12. The apparatus of claim 10, said device to control the transmission of the frame based on the time slot to cause the transmission of the frame in the correct time slot and the correct direction for a subscriber station that is to receive the communication.

13. The apparatus of claim 9 wherein said apparatus is a relay.

14. The apparatus of claim 13 wherein said apparatus is a base station to subscriber station relay.

15. The apparatus of claim 9 wherein said information is a map field.

16. The apparatus of claim 9 wherein the rest of the frame that is not decoded is not re-encoded.

17. The apparatus of claim 10 wherein said information is service information contained in a beacon field.

18. The apparatus of claim 9 including a relay chain and a controller, said relay chain including a switch controlled by said controller to cause transmission to occur in a time slot once said user is communicating through said relay.

19. The apparatus of claim 9, said apparatus to transmit only during a time slot in which a user of said relay is communicating.
